(19) United States
(12) Patent Application Publication
(10) Pub. No.: US 2007/0217323 A1
(43) Pub. Date: Sep. 20, 2007

(54) Apparatus and method for reducing inter-subcarrier interference in OFDMA system

(75) Inventors: Seong-Yun Ko, Suwon-si (KR); Joo-Yong Park, Seongnam-si (KR); Myeon-Kee Youn, Namdong-gu (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/602,067

(22) Filed: Nov. 20, 2006

(30) Foreign Application Priority Data
Mar. 20, 2006 (KR) 2006-25443

(51) Int. Cl. H04J 3/10; H04J 11/00

(52) U.S. Cl. 370/201; 370/208

(57) ABSTRACT

An apparatus and method for reducing inter-subcarrier interference (ICI) in an Orthogonal Frequency Division Multiple Access (OFDMA) system are provided. The method includes determining a correction frequency from uplink intermediate frequency (IF) signals subjected to analog-to-digital conversion when an uplink radio frequency (RF) signal is input through an antenna of a base station and each uplink IF signal (I(n)+j1(n)) is input,; and correcting the uplink IF signal so as to correspond to the determined correction frequency. Thereby, it is possible to reduce the ICI of each terminal caused by mismatching of the interval of the inter-subcarrier center frequency of each terminal that constitutes the uplink signal in the OFDMA system.

This application claims the benefit under 35 U.S.C. §119(a) from an application entitled “APPARATUS AND METHOD FOR REDUCING INTER-SUBCARRIER INTERFERENCE IN OFDMA SYSTEM” filed in the Korean Intellectual Property Office on Mar. 20, 2006 and assigned Serial No. 2006-25443, the entire contents of which are incorporated herein by reference.

### BACKGROUND OF THE INVENTION

1. Field of the Invention

The present invention relates generally to interference reduction, and more particularly to an apparatus and method for reducing inter-subcarrier interference (ICI) in an Orthogonal Frequency Division Multiple Access (OFDMA) system.

2. Description of the Related Art

Orthogonal Frequency Division Multiplexing (OFDM) is generally a technology for carrying information to be transmitted on a plurality of mutually orthogonal sub-carriers.

OFDM is similar to Frequency Division Multiplexing (FDM) in that it uses many sub-carriers. OFDM allows for spectrum overlapping between the sub-carriers due to their mutual orthogonality, and has high bandwidth efficiency compared to FDM.

Further, an OFDM transmission system uses an OFDM symbol that is considerably longer than the impulse response of a channel, making it highly resistant to multi-path fading. In addition, the OFDM transmission system has a long symbol compared to a single carrier system, making it advantageous for high-speed transmission.

The conventional transmission system based on OFDM generally includes an OFDM transmitter and receiver.

The OFDM transmitter is for converting raw data to be transmitted by the bit into an OFDM symbol, and carrying the OFDM symbol on a radio frequency carrier. The OFDM receiver is for receiving the OFDM symbol transmitted by the OFDM transmitter of the terminal, and restoring the raw data transmitted at a transmission stage.

In the commercialized OFDM system, it is more difficult to implement the receiver than the transmitter, and the performance of the receiver exerts a greater influence on transmission performance of the entire system than the performance of the transmitter.

This is because the transmitter does not account for signal distortion, and thus generates an OFDM symbol having a high signal-to-noise (S/N) ratio, while the receiver should use a complicated signal-processing algorithm for restoring a signal distorted by a wireless channel having multi-path properties and imperfect analog components. Furthermore, the signal-processing algorithm used herein varies depending on the system.

In general, the performance of a receiver improves as the complexity of its signal processing scheme increases. However, receivers with complex signal processing schemes are difficult to implement, and the size of their semiconductor components and their consumption of power tends to increase.

Meanwhile, because desired data can be carried on each sub-carrier, the OFDM system can be used as a multiple access system I called Orthogonal Frequency Division Multiple Access (OFDMA).

In a conventional transmission system based on OFDMA, a downlink signal is generated only by the transmitter of a base station, and each terminal receiving the generated downlink signal decodes the received signal, and extracts only its own information.

An uplink signal received by the base station is the sum of signals generated by the terminals, each of which is assigned a different sub-carrier and symbol interval. The receiver of the base station can thus experience decreased reception.

More specifically, there is a difference in a reference clock frequency used by different terminals to generate the OFDM signal, and thereby the orthogonality between the sub-carriers constituting the uplink signal is easily disrupted.

Here, the conventional OFDMA-based transmission system communicates with at least two terminals.

Further, it is assumed in first and second terminals that the sub-carriers having center frequencies fc_station1 and fc_station2 are alternately located as shown in FIGS. 1A and 1B, and the symbol generated by each terminal has a constant length that is indicated by T.

Accordingly, an uplink RF signal including the sub-carriers of the first and second terminals is as shown in FIG. 1C. When a sub-carrier interval between neighboring sub-carriers in the uplink RF signal is given by Equation 1, orthogonality is maintained.

Δf=1/T (1)

where T is the symbol length of the transmission carrier frequency signal.

Although each sub-carrier has complete orthogonality in each terminal, the transmission carrier frequency signals of terminals do not match, and thus Δf is not maintained between the carriers in the uplink signal, the sum of the signals of the terminals.

In the conventional OFDMA-based transmission system, when an offset between the transmission carrier frequency signals of the terminals generating the uplink signal takes place, orthogonality between sub-carriers handling the uplink signal is distorted. Accordingly, inter-subcarrier interference results, which directly deteriorates reception performance.

### SUMMARY OF THE INVENTION

It is an object of the present invention to provide an apparatus and method for reducing inter-subcarrier interference (ICI) in an Orthogonal Frequency Division Multiple Access (OFDMA) system, capable of improving reception performance of a transmission carrier frequency signal having an orthogonality that is deteriorated by offset of a transmission carrier frequency between different terminals in the OFDMA system.

According to the present invention, there is provided an apparatus for reducing inter-subcarrier interference (ICI) in an Orthogonal Frequency Division Multiple Access (OFDMA) system, including a successive interference cancellation (SIC) corrector that, when each uplink intermediate frequency (IF) signal (I(n)+j1(n)) subjected to analog-to-digital conversion of a radio frequency (RF) signal is received through an antenna of a base station, determines an average correction frequency of terminals from each uplink IF signal, and corrects the uplink IF signals so as to correspond to the average correction frequency.

The SIC corrector may be performed in a time domain, and includes a sub-carrier selector that searches information of an uplink mapping table when the uplink IF signal is input and selects a corresponding terminal, a correction frequency detector estimating a frequency offset between a transmission carrier signal of each terminal searched through the sub-carrier selector and a center frequency of the base station, and then determining an average value of the estimated frequency offsets of all terminals as the correction frequency, and a frequency corrector correcting a transmission carrier frequency of the terminal which is to be restored using the correction frequency determined through the correction frequency detector.

The frequency corrector may process in parallel the transmission carrier frequency of each terminal through at least one frequency corrector, or may further include a data storage in order to process in series the transmission carrier frequency of each terminal.

The frequency corrector may multiply the transmission carrier frequency of each terminal by Equation 2:

exp(−j2πΔf_{corr}nT_{S}) (2)

where Δf_{corr} is the correction frequency, n is the index of the terminal to be restored and T_{S} is the sampling period of the receiver.

Further, the frequency corrector may select the terminal to be restored.

According to the present invention, there is provided a method for reducing inter-subcarrier interference (ICI) in an Orthogonal Frequency Division Multiple Access (OFDMA) system, including determining a correction frequency from the uplink IF signals when an uplink radio frequency (RF) signal is input through an antenna of a base station, and each uplink intermediate frequency (IF) signal (I(n)+j1(n)) subjected to analog-to-digital conversion is input, and correcting the uplink IF signals so as to correspond to the determined correction frequency.

Determining the correction frequency from the uplink IF signals may further include searching information of an uplink mapping table when the uplink IF signals are input and selecting a corresponding terminal, and estimating a frequency offset between a transmission carrier signal of each terminal searched in the step of searching information and a center frequency of the base station, and then determining an average value of the estimated frequency offsets of all terminals as the correction frequency.

Correcting the uplink IF signals so as to correspond to the determined correction frequency may further include processing in parallel the transmission carrier frequency of each terminal through at least one frequency corrector, or temporarily storing data in order to process in series the transmission carrier frequency of each terminal and then processing it according to a time period.

Correcting the uplink IF signals so as to correspond to the determined correction frequency may further include multiplying the transmission carrier frequency of each terminal by Equation 2, given above.

### BRIEF DESCRIPTION OF THE DRAWINGS

The above and other objects, features and advantages of the present invention will become more apparent from the following detailed description in conjunction with the accompanying drawings, in which:

FIGS. 1A and 1B illustrate transmission carrier signals transmitted by terminals;

FIG. 1C illustrates an uplink radio frequency (RF) signal that an OFDMA system receives from terminals;

FIG. 2 is a block diagram illustrating the construction of an apparatus for reducing inter-subcarrier interference (ICI) in an OFDMA system according to the present invention;

FIG. 3 is a block diagram illustrating a detailed construction of the successive interference cancellation (SIC) corrector in the apparatus for reducing ICI in an OFDMA system according to FIG. 2;

FIG. 4A is a block diagram illustrating a construction for processing in parallel an sub-carrier of each terminal in the apparatus for reducing ICI in an OFDMA system according to FIG. 2;

FIG. 4B is a block diagram illustrating a construction for processing in series a sub-carrier of each terminal in the apparatus for reducing ICI in an OFDMA system according to FIG. 2;

FIG. 5 is a flowchart illustrating a method for reducing ICI in an OFDMA system according to the present invention;

FIG. 6 is a flowchart illustrating in detail the first step S1 in the method for reducing ICI in an OFDMA system according to FIG. 5;

FIG. 7A illustrates a sub-carrier demodulated through a conventional OFDMA system; and

FIG. 7B illustrates a sub-carrier demodulated through the apparatus and method for reducing ICI in an OFDMA system according to FIGS. 2 and 5.

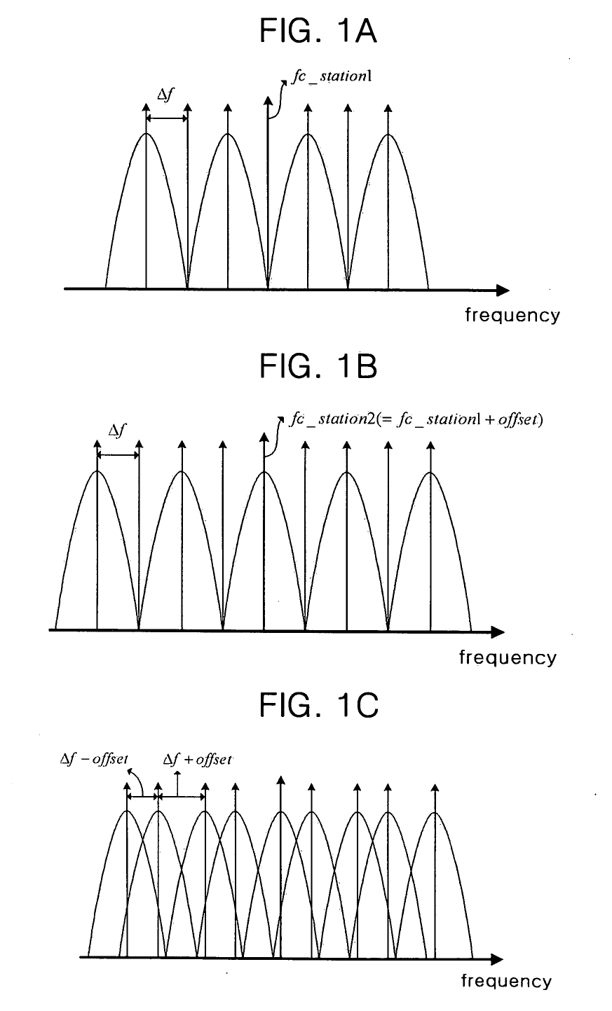

### DETAILED DESCRIPTION OF THE PREFERRED EMBODIMENTS

Hereinafter, an apparatus and method for reducing inter-subcarrier interference (ICI) in an Orthogonal Frequency Division Multiple Access (OFDMA) system in accordance with preferred embodiments of the present invention will be described in detail with reference to the accompanying drawings. Here, the system construction described below is only one example of a construction falling within the scope of the present invention, and thus the present invention is not limited thereto. Additionally, detailed explanations for well-known functions and compositions are omitted for the sake of clarity and conciseness.

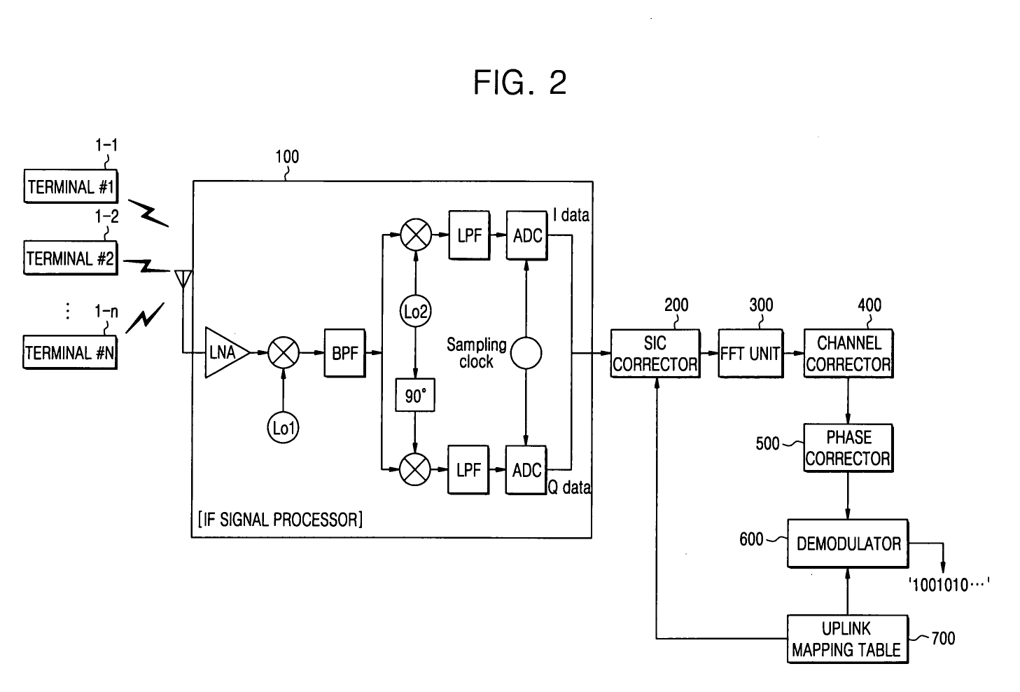

FIG. 2 illustrates the construction of an apparatus for reducing ICI in an OFDMA system, according to the present invention. The apparatus for reducing the ICI in the OFDMA system includes an intermediate frequency (IF) signal processor 100, a successive interference cancellation (SIC) corrector 200, a Fast Fourier Transform (FFT) unit 300, a channel corrector 400, a phase corrector 500, a demodulator 600 and an uplink mapping table 700.

In the IF signal processor 100, when an uplink radio frequency (RF) signal is received through an antenna, the uplink RF signal is subjected to low-noise amplification through a low noise amplifier (LNA), multiplied by an IF signal supplied from a first local oscillator Lo1, and down-converted into an uplink IF signal. In order to split the uplink IF signal into I and Q signals, the uplink IF signal is multiplied by each of cos(2πfIFt) and −sin(2πfIFt) signals supplied from a second local oscillator Lo2, passes through each Analog-to-Digital Converter (ADC), and thereby splits into I and Q signals of a baseband. Here, the IF signal processor 100 is an ordinary component used in the conventional OFDMA-based transmission system, and thus reference numbers of its detailed components are not represented.

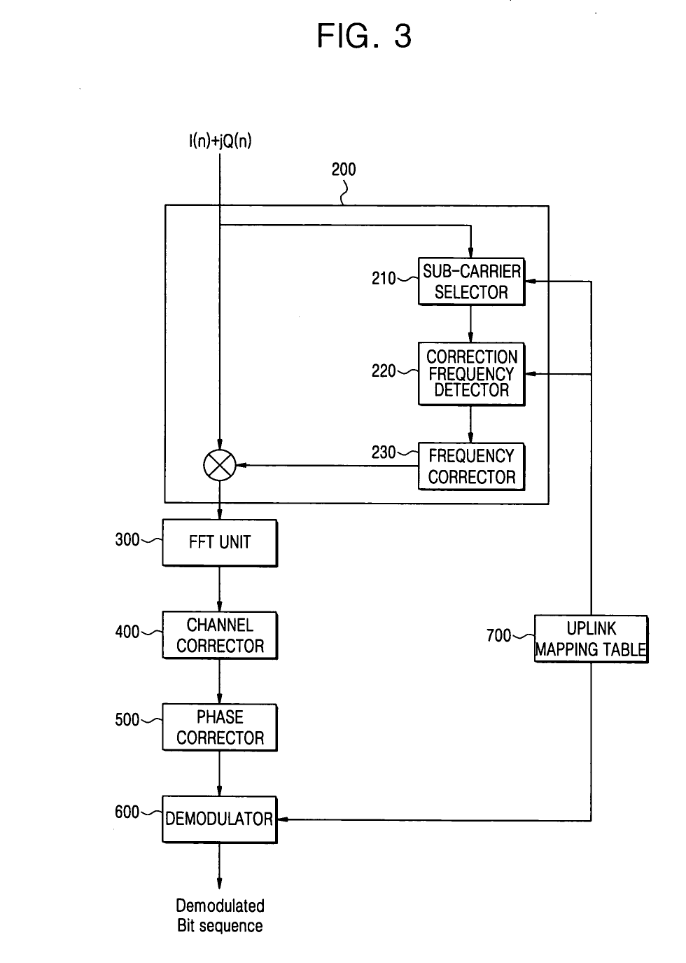

The SIC corrector 200 determines a correction frequency of the uplink IF signal split into I and Q signals of the baseband, and corrects the uplink IF signal so as to correspond to the correction frequency. The SIC corrector 200 includes a sub-carrier selector 210, a correction frequency detector 220 and a frequency corrector 230, as shown in FIG. 3.

When the uplink IF signal split into I and Q signals is input, the sub-carrier selector 210 of the SIC corrector 200 searches information of the uplink mapping table 700, and selects a corresponding terminal.

The correction frequency detector 220 of the SIC corrector 200 estimates a frequency offset between a transmission carrier signal of each terminal searched through the sub-carrier selector 210 and a center frequency of the base station, and then determines an average value of the estimated frequency offsets of all terminals as the correction frequency.

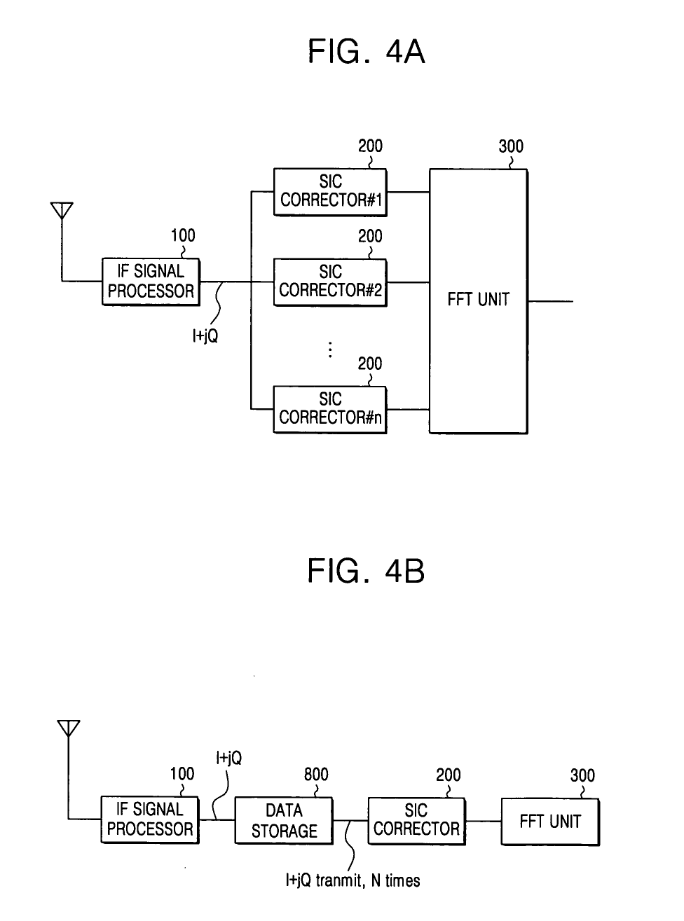

The frequency corrector 230 of the SIC corrector 200 corrects a transmission carrier frequency of the terminal which is to be restored using the correction frequency determined through the correction frequency detector. As shown in FIG. 4A, the transmission carrier frequency of each terminal is processed in parallel through at least one frequency corrector 230, and is corrected by multiplication of Equation 2, given above.

In order to process in series the transmission carrier frequency of each terminal through the frequency corrector 230 of the SIC corrector 200, a data storage 800 is additionally required as shown in FIG. 4B. The transmission carrier frequency of each terminal is corrected by multiplication of Equation 2.

In other words, when the center frequency of the uplink signal of the time domain is corrected, a method of correcting a center frequency of a baseband discrete signal I(n)+jQ(n) is undergone. The method improves over a method of correcting a center frequency at an analog stage (IF signal processor). Therefore, because the discrete signal can be stored in a memory or buffer, when the signals of all the terminals generating the uplink signal are to be restored by the method proposed in the present invention, both a parallel and a vertical processing structure can be used.

Correcting the center frequency of the signal I(n)+jQ(n) is followed by determining the correction frequency from the uplink IF signal. Although the correcting of the center frequency is not processed on real time, there is no data loss of the signal I(n)+jQ(n). Hence, when is implemented, the restriction of a up link signal processing speed is not strict.

The FFT unit 300 converts the transmission carrier frequency, which is corrected in the time domain through the frequency corrector 230, into the signal of a frequency domain. The signal output by the FFT unit 300 is a Quadrature Amplitude Modulation (QAM) signal carried on the sub-carrier.

The channel corrector 400 and the phase corrector 500 correct phase distortion caused by the influence of a wireless channel between the terminal transmitting the QAM signal intended for restoration and the base station, and other physical defects.

Further, the demodulator 600 determines a QAM symbol compensated for the influence of the wireless channel and other physical defects using hardware or software, demodulates the determined QAM symbol, and transmits it to a component such as a channel decoder.

The basic function and detailed operation of each of the above-mentioned components will be omitted for the sake of clarity and conciseness, and rather it's the general operation of these components with respect to the present invention will be described.

When an uplink radio frequency (RF) signal having 2345.005 MHz as the center frequency of a transmission carrier transmitted from a first terminal 1-1 and 2345.005 MHz as the center frequency of a transmission carrier transmitted from a second terminal 1-2, is received through an antenna, the LNA of the IF signal processor 100 performs low-noise amplification on the uplink RF signal in order to restore signal intensity.

Subsequently, the uplink RF signal is multiplied by an IF signal supplied from the first local oscillator Lo1, and thereby is down-converted into an uplink IF signal.

To split the uplink IF signal into I and Q signals, the uplink IF signal is multiplied by each of cos(2πfIFt) and −sin(2πfIFt) signals supplied from a second local oscillator, and passes through each Analog-to-Digital Converter (ADC). Then, the uplink IF signal is split into I and Q signals of a baseband.

The SIC corrector 200 determines a correction frequency of the uplink IF signal split into I and Q signals of the baseband, and corrects the uplink IF signal so as to correspond to the correction frequency. When the uplink IF signal split into I and Q signals is input, the sub-carrier selector 210 of the SIC corrector 200 searches information of the uplink mapping table 700, and then selects a terminal.

The correction frequency detector 220 of the SIC corrector 200 estimates a frequency offset between the center frequency of the transmission carrier signal of each terminal searched through the sub-carrier selector 210 and the center frequency of the carrier of the base station, and then determines an average value of the estimated frequency offset values of all terminals as the correction frequency. Here, the correction frequency detector 220 of the SIC corrector 200 estimates the offset value, 0.005 MHz, between the center frequency (2345.005 MHz) of the transmission carrier signal of the first terminal 1-1 and the center frequency (2345 MHz) of the carrier of the base station from the uplink IF signal, and then determines the average value, 0.005 MHz, of the estimated offset value, 0.005 MHz, of the first terminal 1-1 and the estimated offset value, 0.005 MHz, of the second terminal 1-2 as the correction frequency.

The frequency corrector 230 of the SIC corrector 200 corrects a transmission carrier frequency of the terminal which is to be restored using the correction frequency, 0.005 MHz, determined through the correction frequency detector. The transmission carrier frequency of each terminal is processed in parallel through at least one frequency corrector 230.

In order to process in series the transmission carrier frequency of each terminal through the frequency corrector 230 of the SIC corrector 200, the data storage 800 may be additionally required.

In the frequency corrector 230 of the SIC corrector 200, the transmission carrier frequency of each terminal is corrected by multiplication in Equation 2.

The FFT unit 300 converts the transmission carrier frequency, which is corrected in the time domain through the frequency corrector 230, into the signal of the frequency domain. The signal output by the FFT unit 300 is the QAM signal carried on the sub-carrier.

The channel corrector 400 and the phase corrector 500 correct the phase distortion caused by the influence of the wireless channel between the terminal transmitting the QAM signal intended for restoration and the base station, and other physical defects.

Next, the demodulator 600 determines a QAM symbol compensated for the influence of the wireless channel and other physical defects using hardware or software, demodulates the determined QAM symbol, and transmits the demodulated QAM symbol to a component such as a channel decoder.

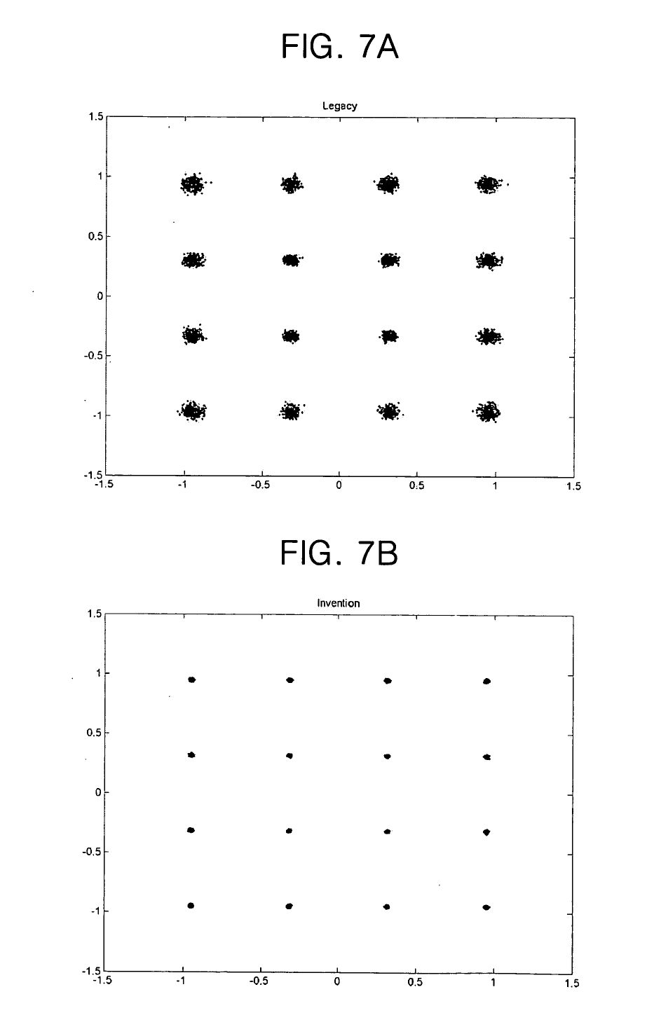

The corrected transmission carrier signal of the terminal that is restored through the conventional method is shown in FIG. 7A, and the transmission carrier signal restored based on the present invention is shown in FIG. 7B.

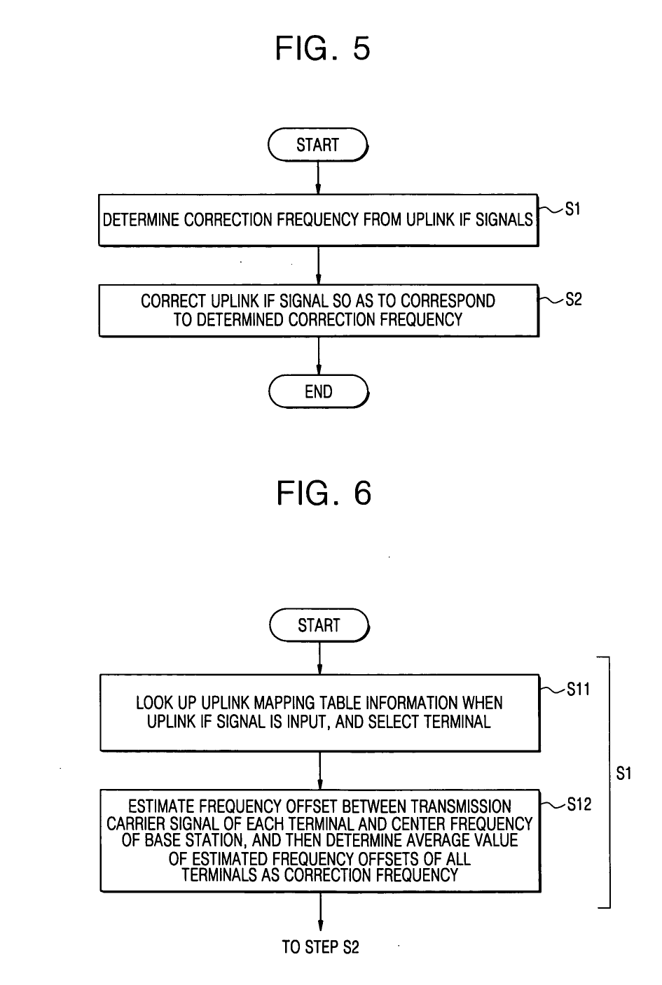

A method for reducing inter-subcarrier interference in the OFDMA system having the above-described configuration according to the present invention will be described with reference to FIG. 5.

First, when an uplink RF signal, in which the center frequency of the transmission carrier transmitted from the first terminal 1-1 is 2345.005 MHz and the center frequency of the transmission carrier transmitted from the second terminal 1-2 is 2345.005 MHz, is received through an antenna, the low-noise amplifier of the IF signal processor 100 performs low-noise amplification on the uplink RF signal in order to restore signal intensity.

The uplink RF signal is multiplied by an IF signal supplied from the first local oscillator, and is down-converted into an uplink IF signal.

To split the uplink IF signal into I and Q signals, the uplink IF signal is multiplied by each of cos(2πfIFt) and −sin(2πfIFt) signals supplied from the second local oscillator, and passes through each ADC. Then, the uplink IF signal is split into I and Q signals of a baseband, and are corrected in a time domain.

Therefore, when the uplink RF signal is input through the antenna of the base station, and each uplink IF signal I(n)+j1(n) passing through each ADC is input, a correction frequency is determined from the uplink IF signal (S1).

Step S1 of determining the correction frequency from the uplink IF signal will now be described in detail with reference to FIG. 6.

When the uplink IF signal is input, information of the uplink mapping table 700 is searched to select a terminal (S11).

After a frequency offset between the center frequency of the transmission carrier signal of each terminal searched through the sub-carrier selector 210 and the center frequency of the carrier of the base station is estimated, an average value of the estimated frequency offset values of all terminals is determined as the correction frequency (S12).

Referring back to FIG. 5, the uplink IF signal is corrected so as to correspond to the determined correction frequency (S2). In step S2, through at least one frequency corrector 230, transmission carrier frequencies of terminals are processed in parallel, or data is temporarily stored in order to process in series the transmission carrier frequency of each terminal.

In this manner, step S2 of correcting the uplink IF signal so as to correspond to the determined correction frequency is corrected by multiplying the transmission carrier frequency of each terminal in Equation 2, and selects a terminal to be restored.

As set forth above, according to the apparatus and method for reducing the ICI in the OFDMA system, it is possible to reduce the ICI of each terminal caused by mismatching of the interval of the inter-subcarrier center frequency of each terminal that constitutes the uplink signal in the OFDMA.

Thus, it is possible to not only improve reception performance of the base station, but also perform more reliable communication over the conventional art.

While the present invention has been described with reference to the preferred embodiments, it should be understood to those skilled in the art that various other modifications and changes may be provided within the spirit and scope the present invention defined in the following claims.

What is claimed is:

1. An apparatus for reducing inter-subcarrier interference (ICI) in an Orthogonal Frequency Division Multiple Access (OFDMA) system, the apparatus comprising:
a successive interference cancellation (SIC) corrector that, when each uplink intermediate frequency (IF) signal subjected to analog-to-digital conversion of a radio frequency (RF) signal is received through an antenna of a base station, determines an average correction frequency of terminals from the uplink IF signals, and corrects the uplink IF signals so as to correspond to the average correction frequency.

2. The apparatus according to claim 1, wherein the SIC corrector is performed in a time domain.

3. The apparatus according to claim 1, wherein the SIC corrector comprises:
a sub-carrier selector for searching information of an uplink mapping table when the uplink IF signal is input, and selecting a corresponding terminal;
a correction frequency detector for estimating a frequency offset between a transmission carrier signal of each terminal searched through the sub-carrier selector and a center frequency of the base station, and then determining an average value of the estimated frequency offsets of all terminals as the correction frequency; and
a frequency corrector for correcting a transmission carrier frequency of the terminal which is to be restored using the correction frequency determined through the correction frequency detector.

4. The apparatus according to claim 3, wherein the frequency corrector processes in parallel the transmission carrier frequency of each terminal through at least one frequency corrector.

5. The apparatus according to claim 3, wherein the frequency corrector further comprises a data storage in order to process in series the transmission carrier frequency of each terminal.

6. The apparatus according to claim 4, wherein the frequency corrector further comprises a data storage in order to process in series the transmission carrier frequency of each terminal.

7. The apparatus according to claim 3, wherein the frequency corrector multiplies the transmission carrier frequency of each terminal by
exp(−j2πΔf_{corr}nT_{S})
where Δf_{corr} is the correction frequency, n is the index of the terminal to be restored and T_{S} is the sampling period of the receiver.

8. The apparatus according to claim 3, wherein the frequency corrector selects the terminal to be restored.

9. A method for reducing inter-subcarrier interference (ICI) in an Orthogonal Frequency Division Multiple Access (OFDMA) system, the method comprising the steps of:
determining a correction frequency from uplink intermediate frequency (IF) signals subjected to analog-to-digital conversion, when an uplink radio frequency (RF) signal is input through an antenna of a base station and the uplink (IF) signals are input; and
correcting the uplink IF signals so as to correspond to the determined correction frequency.

10. The method according to claim 9, wherein correcting the uplink IF signals is performed in a time domain.

11. The method according to claim 9, wherein determining a correction frequency from the uplink IF signals further comprises:
searching information of an uplink mapping table when the uplink IF signals are input, and selecting a corresponding terminal; and
estimating a frequency offset between a transmission carrier signal of each terminal when searching the information and a center frequency of the base station, and determining an average value of the estimated frequency offsets of all terminals as the correction frequency.

12. The method according to claim 9, wherein correcting the uplink IF signals so as to correspond to the determined correction frequency further comprises processing in parallel the transmission carrier frequency of each terminal through at least one frequency corrector.

13. The method according to claim 12, wherein correcting the uplink IF signals so as to correspond to the determined correction frequency further comprises temporarily storing data in order to process in series the transmission carrier frequency of each terminal.

14. The method according to claim 9, wherein correcting the uplink IF signals so as to correspond to the determined correction frequency comprises temporarily storing data in order to process in series the transmission carrier frequency of each terminal.

15. The method according to claim 9, wherein correcting the uplink IF signals so as to correspond to the determined correction frequency further comprises multiplying the transmission carrier frequency of each terminal by
exp(−j2πΔf_{corr}nT_{S})
where Δf_{corr} is the correction frequency, n is the index of the terminal to be restored and T_{S} is the sampling period of the receiver.

16. The method according to claim 9, wherein correcting the uplink IF signals so as to correspond to the determined correction frequency further comprises selecting the terminal to be restored.
